(19) United States
(12) Patent Application Publication
(10) Pub. No.: US 2017/0325088 A1
(43) Pub. Date: Nov. 9, 2017

(54) SECURING SENSOR STATUS BY LEVERAGING ALWAYS-ON PROCESSOR AND HOST-BASED TRUSTED EXECUTION

(71) Applicant: QUALCOMM Incorporated, San Diego, CA (US)

(72) Inventors: Adam Edward NEWHAM, Poway, CA (US); Osman KOYUNCU, San Diego, CA (US); Chandrasekhar GHANTA, San Diego, CA (US); Ivan McLean, San Diego, CA (US); Stuart MOSKOVICS, San Diego, CA (US); Rashid Ahmed Akbar Attar, San Diego, CA (US); Justin McGloin, Los Altos, CA (US)

(21) Appl. No.: 15/174,673

(22) Filed: Jun. 6, 2016

Related U.S. Application Data
(60) Provisional application No. 62/332,253, filed on May 5, 2016.

(51) Int. Cl. H04W 12/06; H04W 12/10

(52) U.S. Cl. CPC H04W 12/06; H04W 12/10

(57) ABSTRACT

Techniques for securing transactions on a mobile device are provided. An example method according to these techniques includes receiving an input of a code to authorize a transaction in a security sensitive application, authenticating the transaction responsive to the input of the code, monitoring sensor information indicative of a context change, and authorizing subsequent transactions responsive to the sensor information indicating that the context change has not occurred since receiving the input of the code.

### CROSS REFERENCE TO RELATED APPLICATION

This application claims priority to U.S. Provisional Patent Application Ser. No. 62/332,253, entitled “SECURING SENSOR STATUS BY LEVERAGING ALWAYS-ON PROCESSOR AND HOST-BASED TRUSTED EXECUTION,” filed on May 5, 2016, which is assigned to the assignee hereof and incorporated by reference.

### BACKGROUND

Sensors have a wide variety of applications in mobile devices. But monitoring and processing the signals output by such sensors can be processor intensive. A solution for securely handing of the monitoring and processing of the signal output by the sensors to another processor is desired.

### SUMMARY

An example method for secure transactions on a mobile device according to the disclosure includes receiving an input of a code to authorize a transaction in a security sensitive application, authenticating the transaction responsive to the input of the code, monitoring sensor information indicative of a context change, and authorizing subsequent transactions responsive to the sensor information indicating that the context change has not occurred since receiving the input of the code.

Implementations of such a method may include one or more of the following features. The context change is indicative of the mobile device having been removed by a user of the mobile device. The mobile device comprises a photoplethysmogram (PPG) sensor, and monitoring the sensor information comprises monitoring the sensor information from the PPG sensor. Monitoring the sensor information indicative of the context change includes receiving a signal from a sensor at a first processor indicative of whether the context change has occurred, and setting a value in a protected memory location of the first processor indicative of whether the context change has occurred. The signal from the sensor is indicative of whether the mobile device is being worn by a user of the mobile device, and the value in the protected memory location is indicative of whether the mobile device is being worn by the user of the mobile device. Setting the value in the protected memory location of the first processor indicative of whether the context change has occurred includes determining at the first processor whether the context change has occurred based on the signal from the sensor, setting the value in the protected memory location of the first processor to a value indicating that the context change has occurred responsive to the context change having occurred, and preventing the value in the protected memory location from being updated responsive to the signal from the sensor until a signal is received from a second processor. Authorizing the subsequent transactions responsive to the sensor information indicating that the context change has not occurred since receiving the input of the code includes receiving a request to perform a subsequent transaction at a second processor, obtaining the value from the protected memory location of the first processor, and authorizing the subsequent transactions responsive to the value in the protected memory location indicating that the context change has not occurred. Obtaining the value from the protected memory location of the first processor includes retrieving the value from the protected memory location of the first processor using a secure interface between the first processor and a trusted execution environment of the second processor. Denying the subsequent transaction responsive to the value in the protected memory location indicating that the context change has occurred. Requesting, by the second processor, entry of the code to authorize the subsequent transaction, and requesting, by the second processor, that the first processor make a determination whether a user is wearing the mobile device based on the sensor information and set the value in the protected memory location based on the sensor information. Booting the first processor and the second processor, the second processor being booted prior the first processor, and the first processor being configured to enter into a secure download mode upon booting in which the first processor is configured to receive a software image from a trusted execution environment of the second processor, authenticating the software image to be executed by the first processor using the trusted execution environment of the second processor; and downloading the software image to the first processor from the trusted execution environment of the second processor via secure interface between the trusted execution environment of the second processor and the first processor.

A non-transitory, computer-readable medium according to the disclosure, having stored thereon computer-readable instructions for secure transactions on a mobile device includes instructions configured to cause at least one processor to: receive an input of a code to authorize a transaction in a security sensitive application, authenticate the transaction responsive to the input of the code, monitor sensor information indicative of a context change, and authorize subsequent transactions responsive to the sensor information indicating that the context change has not occurred since receiving the input of the code.

Implementations of such a non-transitory, computer-readable medium may include one or more of the following features. The context change is indicative of the mobile device having been removed by a user of the mobile device. The mobile device comprises a photoplethysmogram (PPG) sensor, and the instructions configured to cause the at least one processor to monitor the sensor information include instructions configured to cause the at least one processor to monitor the sensor information from the PPG sensor. The instructions configured to cause the at least one processor to monitor the sensor information indicative of the context change include instructions configured to cause the at least one processor to receive a signal from a sensor at a first processor indicative of whether the context change has occurred, and set a value in a protected memory location of the first processor indicative of whether the context change has occurred. The signal from the sensor is indicative of whether the mobile device is being worn by a user of the mobile device, and the value in the protected memory location is indicative of whether the mobile device is being worn by the user of the mobile device. The instructions configured to cause the at least one processor to set the value in the protected memory location of the first processor indicative of whether the context change has occurred include instructions configured to cause the at least one processor to determine at the first processor whether the context change has occurred based on the signal from the sensor; set the value in the protected memory location of the first processor to a value indicating that the context change has occurred responsive to the context change having occurred, and prevent the value in the protected memory location from being updated responsive to a signal from the sensor until a signal is received from a second processor. The instructions to cause the at least one processor to authorize the subsequent transactions responsive to the sensor information indicating that the context change has not occurred since receiving the input of the code include instructions configured to cause the at least one processor to receive a request to perform a subsequent transaction at a second processor, obtain the value from the protected memory location of the first processor, and authorize the subsequent transactions responsive to the value in the protected memory location indicating that the context change has not occurred. The instructions configured to cause the at least one processor to obtain the value from the protected memory location of the first processor include instructions configured to cause the at least one processor to retrieve the value from the protected memory location of the first processor using a secure interface between the first processor and a trusted execution environment of the second processor. Instructions configured to cause the at least one processor to deny the subsequent transaction responsive to the value in the protected memory location indicating that the context change has occurred. Instructions configured to cause the at least one processor to request, by the second processor, entry of the code to authorize the subsequent transaction, and request, by the second processor, that the first processor make a determination whether a user is wearing the mobile device based on the sensor information and set the value in the protected memory location based on the sensor information. Instructions configured to cause the at least one processor to boot the first processor and the second processor, the second processor being booted prior the first processor, and the first processor being configured to enter into a secure download mode upon booting in which the first processor is configured to receive a software image from a trusted execution environment of the second processor, authenticate the software image to be executed by the first processor using the trusted execution environment of the second processor, and download the software image to the first processor from the trusted execution environment of the second processor via secure interface between the trusted execution environment of the second processor and the first processor.

An example mobile device according to the disclosure comprises a first processor and a second processor being communicatively coupled to enable communications between the first processor and the second processor. The second processor is configured to receive an input of a code to authorize a transaction in a security sensitive application, and to authenticate the transaction responsive to the input of the code. The first processor is configured to monitor sensor information indicative of a context change, and provide information indicative of the context change to the second processor. The second processor being further configured to authorize subsequent transactions responsive to the information indicating that the context change has not occurred since receiving the input of the code.

Implementations of such a mobile device may include one or more of the following features. The context change is indicative of the mobile device having been removed by a user of the mobile device. The mobile device comprises a photoplethysmogram (PPG) sensor, and the first processor is configured to monitor the sensor information from the PPG sensor. The first processor being configured to monitor the sensor information indicative of the context change is further configured to receive a signal from a sensor at the first processor indicative of whether the context change has occurred, and set a value in a protected memory location of the first processor indicative of whether the context change has occurred. The signal from the sensor is indicative of whether the mobile device is being worn by a user of the mobile device, and wherein the value in the protected memory location is indicative of whether the mobile device is being worn by the user of the mobile device. The first processor being configured to set the value in the protected memory location of the first processor indicative of whether the context change has occurred is further configured to determine at the first processor whether the context change has occurred based on the signal from the sensor, set the value in the protected memory location of the first processor to a value indicating that the context change has occurred responsive to the context change having occurred, and prevent the value in the protected memory location from being updated responsive to a signal from the sensor until a signal is received from the second processor. The second processor being configured to authorize the subsequent transactions responsive to the sensor information indicating that the context change has not occurred since receiving the input of the code is further configured to receive a request to perform a subsequent transaction at the second processor, obtain the value from the protected memory location of the first processor, and authorize the subsequent transactions responsive to the value in the protected memory location indicating that the context change has not occurred. The second processor being configured to obtain the value from the protected memory location of the first processor is further configured to retrieve the value from the protected memory location of the first processor using a secure interface between the first processor and a trusted execution environment of the second processor. The second processor is further configured to deny the subsequent transaction responsive to the value in the protected memory location indicating that the context change has occurred. The second processor is further configured to request entry of the code to authorize the subsequent transaction, and request that the first processor make a determination whether a user is wearing the mobile device based on the sensor information and set the value in the protected memory location based on the sensor information. The second processor is configured to boot prior the first processor, the first processor is configured to enter into a secure download mode upon booting in which the first processor is configured to receive a software image from a trusted execution environment of the second processor, the first processor is configured to authenticate the software image to be executed by the first processor using the trusted execution environment of the second processor; and the first processor is configured to download the software image to the first processor from the trusted execution environment of the second processor via secure interface between the trusted execution environment of the second processor and the first processor.

An example apparatus for secure transactions on a mobile device according to the disclosure includes means for receiving an input of a code to authorize a transaction in a security sensitive application, means for authenticating the transaction responsive to the input of the code, means for monitoring sensor information indicative of a context change, and means for authorizing subsequent transactions responsive to the sensor information indicating that the context change has not occurred since receiving the input of the code.

Implementations of such an apparatus may include one or more of the following features. The context change is indicative of the mobile device having been removed by a user of the mobile device. The mobile device comprises a photoplethysmogram (PPG) sensor, and the means for monitoring the sensor information comprises means for monitoring the sensor information from the PPG sensor. The means for monitoring the sensor information indicative of the context change includes means for receiving a signal from a sensor at a first processor indicative of whether the context change has occurred, and means for setting a value in a protected memory location of the first processor indicative of whether the context change has occurred. The signal from the sensor is indicative of whether the mobile device is being worn by a user of the mobile device, and the value in the protected memory location is indicative of whether the mobile device is being worn by the user of the mobile device. The means for setting the value in the protected memory location of the first processor indicative of whether the context change has occurred includes means for determining at the first processor whether the context change has occurred based on the signal from the sensor, means for setting the value in the protected memory location of the first processor to a value indicating that the context change has occurred responsive to the context change having occurred, and means for preventing the value in the protected memory location from being updated responsive to the signal from the sensor until a signal is received from a second processor. The means for authorizing the subsequent transactions responsive to the sensor information indicating that the context change has not occurred since receiving the input of the code includes means for receiving a request to perform a subsequent transaction at a second processor, means for obtaining the value from the protected memory location of the first processor, and means for authorizing the subsequent transactions responsive to the value in the protected memory location indicating that the context change has not occurred. The means for obtaining the value from the protected memory location of the first processor includes means for retrieving the value from the protected memory location of the first processor using a secure interface between the first processor and a trusted execution environment of the second processor. Means for denying the subsequent transaction responsive to the value in the protected memory location indicating that the context change has occurred. Means for requesting, by the second processor, entry of the code to authorize the subsequent transaction; and means for requesting, by the second processor, that the first processor make a determination whether a user is wearing the mobile device based on the sensor information and set the value in the protected memory location based on the sensor information. Means for booting the first processor and the second processor, the second processor being booted prior the first processor, and the first processor being configured to enter into a secure download mode upon booting in which the first processor is configured to receive a software image from a trusted execution environment of the second processor, means for authenticating the software image to be executed by the first processor using the trusted execution environment of the second processor; and means for downloading the software image to the first processor from the trusted execution environment of the second processor via secure interface between the trusted execution environment of the second processor and the first processor.

### BRIEF DESCRIPTION OF THE DRAWING

FIG. 1 is a schematic diagram of an example computing device, in accordance with certain example implementations.

FIG. 2 is a schematic diagram of an example wireless device that can be used to implement the computing device illustrated in FIG. 1, in accordance with certain example implementations.

FIG. 3 is a flow diagram of an example process for secure transactions on a mobile device, in accordance with certain example embodiments.

FIG. 4 is a flow diagram of a process for monitoring sensor information, in accordance with certain example embodiments.

FIG. 5 is a flow diagram of a process for monitoring sensor information, in accordance with certain example embodiments.

FIG. 6 is a flow diagram of a process for authorizing transactions, in accordance with certain example embodiments.

FIG. 7 is a flow diagram of a process for obtaining information from a protected memory location of a processor, in accordance with certain example embodiments.

FIG. 8 is a flow diagram of a process for initializing a first processor and a second processor, in accordance with certain example embodiments.

FIG. 9 is a flow diagram of a process for obtaining information from a protected memory location of a processor, in accordance with certain example embodiments.

Like reference symbols in the various drawings indicate like elements, in accordance with certain example implementations.

### DETAILED DESCRIPTION

Described herein are methods, systems, devices, computer readable media, and other implementations, for implementing secure transactions for a security sensitive application on a computing device, which may be wearable mobile device. The security sensitive transaction may include a financial transactions and/or transactions that access and/or update sensitive data, such as financial data, medical data, and/or other data comprising sensitive information. The techniques disclosed herein can also reduce the number of software images that need to be signed, and thereby also reduce the complexity of key distribution associated with the signing of such software images. A software image can include executable program code, configuration files, and/or data that can be executed by one or more processors of a computing device. The techniques disclosed herein can also multiplex a single interface between a secure and a non-secure mode, which can reduce the number of reduce the number of pins and peripheral interfaces of a processor. The techniques discussed herein can also be used to secure an interrupt from a sensor to a processor, where the interrupt convey a change of state (also referred to herein as a context change). The accompanying drawings and the description below discusses each of these approaches in greater detail.

Example embodiments include, for example, methods including one or more of:
Methods, systems, devices, computer readable media, and other implementations for secure transactions on a mobile device. An example method according to these techniques includes:
   receiving an input of a code to authorize a transaction in a security sensitive application;
   authenticating the transaction responsive to the input of the code;
   monitoring sensor information indicative of a context change; and
   authorizing subsequent transactions responsive to the sensor information indicating that the context change has not occurred since receiving the input of the code.
Implementations of such example systems and methods are illustrated in the accompanying figures and discussed in detail in the following example implementations.

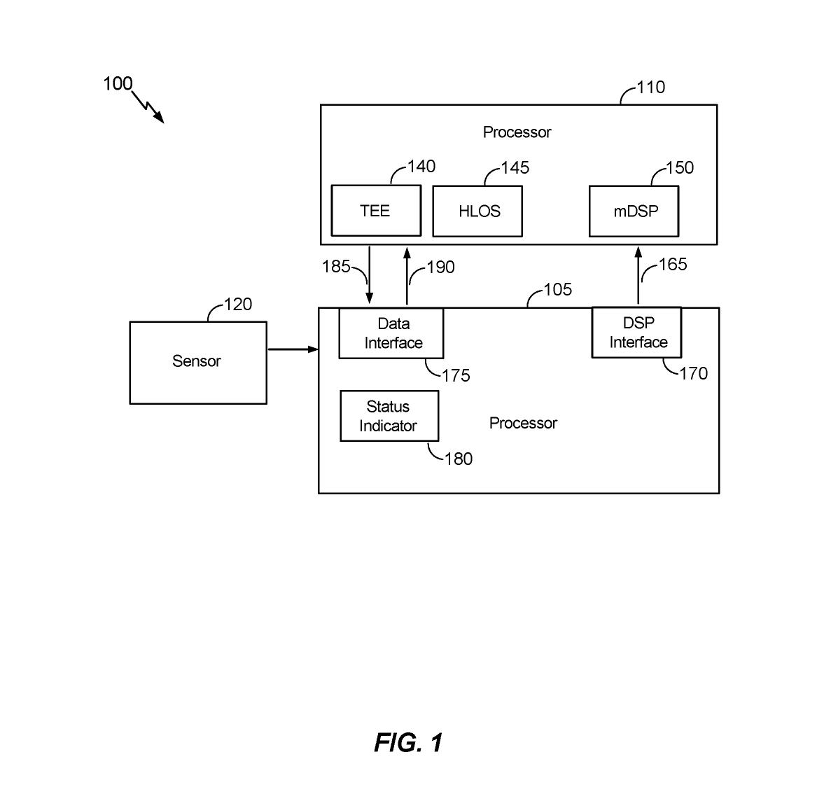

FIG. 1 is a schematic diagram of an example computing device 100 that can be used to implement the techniques disclosed herein. The computing device 100 can comprise a wearable computing device, such a smartwatch or other type of wearable computing device. The computing device 100 may be paired with a secondary computing device (now shown) that can be configured to operate in conjunction with the computing device 100. For example, the secondary computing device may comprise a mobile phone, tablet computer, or other computing device that is configured to interface with the computing device 100 via a wired or wireless connection. The computing device 100 may have a small form factor that limits the resources available to the computing device 100, such as processing power, memory, communications interfaces and/or user interfaces. The computing device 100 can pair with the secondary computing device to make use of one or more resources of the secondary computing device, and the secondary computing device can include one or more applications configured to allow a user to configure one or more functions of the computing device 100.

The computing device 100 includes a first processor 105 and a second processor 110. The first processor 105 and the second processor 110 may comprise one or more microprocessors, microcontrollers, and/or digital signal processors that provide processing functions as well as other calculation and control functionality. The first processor 105 and/or the second processor 110 may also comprise memory that may be on-board the processor (e.g., within the same integrated circuit package as the processor).

The second processor 110 can be configured to provide a trusted execution environment 140 and general purpose execution environment 145. The general purpose execution environment comprises a less secure area of the processor in which general purpose applications and a high-level operating system (HLOS) of the computing device 100 can be executed. The trusted execution environment 140 can be implemented as a secure area of the first processor 105 that can be used to process and store sensitive data in an environment that is segregated from the general purpose execution environment 145 in which the HLOS and/or applications may be executed. The trusted execution environment 140 can be configured to execute trusted applications that provide end-to-end security for sensitive data by enforcing confidentiality, integrity, and protection of the sensitive data stored therein. The trusted execution environment 140 can be used to store encryption keys, and/or other sensitive data. The trusted execution environment 140 can also be configured to provide a secure means for obtaining, authenticating, and/or providing executable software to the first processor 105. The trusted execution environment 140 of the second processor 110 can be configured to obtain a software image to be executed by the first processor 105. The software image may be stored in memory of the computing device 100 (not shown) or may be obtained from an external source, such as by downloading the software image from a content provider over the Internet or another network. The software image can be signed by one or more digital certificates and the trusted execution environment 140 can be configured to authenticate the software image using various means known in the art for authenticating a software image using a digital certificate.

In the example implementation illustrated in FIG. 1, the first processor 105 can be configured to interface with at least one sensor 120 and can be configured to monitor signal data from the at least one sensor 120 and to perform various actions, which will be discussed in greater detail below, based on the signal data from the at least one sensor 120. The first processor 105 can be configured to operate as an “always-on” processor which is remains in an active, powered-up state all or a substantial portion of the time that the computing device 100 is powered up. The first processor 105 can comprise a hardware configuration that typically requires less power to operate than the second processor 110. The second processor 110 may comprise higher processing power and higher power requirements than the first processor 105. At least some components of the second processor 110 may be at least partially powered down when not required to perform processing functions using the trusted execution environment 140, the general purpose execution environment 145, and/or the DSP processing functionality, in order to conserve power on the computing device 100. The computing device 100 may be powered by a battery or other on-board power supply, and reducing the amount of power required to operate the first processor 105 and a second processor 110 may help to significantly extend the amount of time that the computing device 100 may be powered by that power supply before the power supply is exhausted.

The first processor 105 can comprise a secure portion of memory and a non-secure portion of memory. The secure portion of the memory can comprise one or more registers that are configured such that only secure processes operating on the first processor 105 and the trusted execution environment 140 of the second processor 110 can access the contents stored therein. The secure portion of the memory of the first processor 105 can include a secure memory area for storing a status indicator 180. The trusted execution environment 140 can be configured to access the data stored in the status indicator 180 via a secure interface between the first processor 105 and the second processor 110. The data interface 175 can comprise one or pins configured to provide secure access to data stored in the secure memory area of the first processor 105 to the trusted execution environment 140 of the second processor 110. The HLOS and other applications operating in the general purpose execution environment 145 of the second processor 110 may be able to access data stored in non-secure portion of the memory of the first processor 105 but cannot access the data stored in the secure memory area of the first processor 105.

The first processor 105 and the second processor 110 can be configured to multiplex a single data interface, such as the data interface 175 of the first processor 105, for communicating between the first processor 105 and the second processor 110. The data interface 175 to operate in a secure mode and a non-secure mode. Using a single data interface for both secure and non-secure modes of operation can reduce the number of pins and peripheral interfaces required by each of the processors. Furthermore, the data being transmitted between the first processor 105 and the second processor 110 while the data interface 175 is being utilized in the secure mode of operation does not need to be encrypted, because the second processor 110 can be configured such that when a signal is asserted on a particular pin under the control of the trusted execution environment 140 of the second processor 110, the interface is treated as being in the secure operation mode. While the interface is in the secure operation mode, the trusted execution environment 140 of the second processor 110 can send or receive data using the data interface 175, and the general purpose execution environment 145 and/or other components of the second processor cannot send or receive data via the data interface 175. The general purpose execution environment 145 of the second processor 110 can also send and/receive data on the secure interface while the trusted execution environment 140 is operating the secure data interface in the non-secure mode.

In one example implementation, the secure interface between the first processor 105 and the second processor 110 can include a first line 185 and second line 190 which represent a logical communication link between the first processor 105 and the second processor 110. The first line 185 and the second line 190 may be implemented as separate physical interfaces between the first processor 105 and the second processor 110 or may be implemented using the same physical interface. The first line 185 and the second line 190 may be implemented as a Serial Peripheral Interface (SPI) bus connecting the first processor 105 and the second processor 110. The second processor 110 can be configured to operate as the SPI master device and the first processor 105 can be configured to operate as the SPI slave device. Other types of physical interfaces between the first processor 105 and the second processor 110 can also be used.

The trusted execution environment 140 of the second processor 110 can be configured to assert a signal over a specific pin of the second processor 110 to indicate whether the interface is operating in the secure operating mode or the non-secure operating mode. The signal asserted by the trusted execution environment 140 can be received by the over a line between the first processor 105 and the second processor 110, such as the first line 185 or another line (now shown). The first processor 105 can be configured to allow the second processor 110 to access data and/or update data stored in protected memory locations of the first processor 105 responsive to the trusted execution environment asserting the signal to indicate that the data interface is operating in the secure operating mode. While the data interface 175 is being operated in the secure operating mode, the second processor 110 can request the current value of the status indicator 180 from the first processor 105, can request that the status indicator 180 be set to a specific value, and/or request that the first processor 105 perform an action to determine a current context, including processing sensor data from the at least one sensor 120, and to set the status indicator 180 accordingly. The second processor 110 can be configured to send a signal to the first processor 105 over the secure interface to cause the first processor to reset the value of the status indicator 180. The second processor 110 can be configured send such a signal to the first processor 105 responsive to the second processor 110 and/or the first processor 105 being booted up in order to establish the security of the value of the status indicator 180. The status indicator 180 can comprise information related one or more sensors of the at least one sensor 120 and the initial value of the status indicator can be established by the first processor 105 monitoring signals received from the at least one sensor 120. Prior to establishing the value of the status indicator 180 based on monitoring the at least one sensor 120, the first processor 105 can be configured to set the status indicator 180 to a default value. The default value can be used to indicate, for example, that the computing device 100 has been removed or is not being worn by the user or that the status of the computing device 100 has not yet been established.

The second processor 110 can be configured to provide digital signal processing via the DSP functional block 150 for performing various digital signal processing functions. The DSP functionality can comprise hardware configured to efficiently perform DSP-related processing. The first processor 105 can be configured to comprise a DSP interface 170 through which the first processor 105 can communicate with the with the DSP functional block 150 of the second processor 110 in order to defer DSP processing tasks to the second processor 110 when necessary. The first processor 105 may lack the DSP processing functionality of the second processor 110.

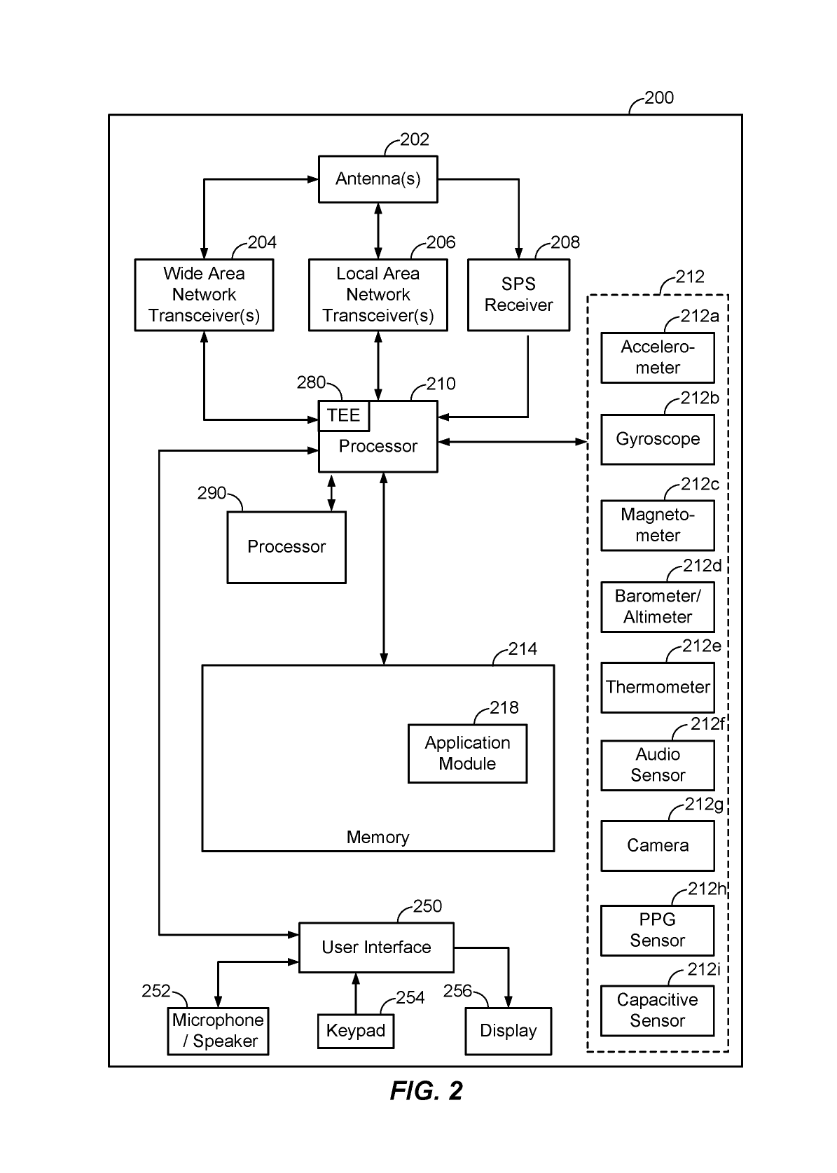

With reference now to FIG. 2, a schematic diagram illustrating various components of an example computing device 200, which may be similar to or the same as the computing device 100 depicted in FIG. 1 is shown and may be used to implement the computing device 100. For the sake of simplicity, the various features/components/functions illustrated in the schematic boxes of FIG. 2 are connected together using a common bus to represent that these various features/components/functions are operatively coupled together. Other connections, mechanisms, features, functions, or the like, may be provided and adapted as necessary to operatively couple and configure a portable wireless device. Furthermore, one or more of the features or functions illustrated in the example of FIG. 2 may be further subdivided, or two or more of the features or functions illustrated in FIG. 2 may be combined. Additionally, one or more of the features or functions illustrated in FIG. 2 may be excluded.

As shown, the computing device 200 may include one or more local area network transceivers 206 that may be connected to one or more antennas 202. The one or more local area network transceivers 206 comprise suitable devices, circuits, hardware, and/or software for communicating with and/or detecting signals to/from one or more of WLAN access points, and/or directly with other wireless devices within a network. In some embodiments, the local area network transceiver(s) 206 may comprise a WiFi (802.11x) communication transceiver suitable for communicating with one or more wireless access points; however, in some embodiments, the local area network transceiver(s) 206 may be configured to communicate with other types of local area networks, personal area networks (e.g., Bluetooth® wireless technology networks), etc. Additionally, any other type of wireless networking technologies may be used, for example, Ultra-Wideband (UWB), ZigBee, wireless Universal Serial Bus (USB), etc.

The computing device 200 may also include, in some implementations, one or more wide area network transceiver(s) 204 that may be connected to the one or more antennas 202. The wide area network transceiver 204 may comprise suitable devices, circuits, hardware, and/or software for communicating with and/or detecting signals from one or more of, for example, the WWAN access points, and/or directly with other wireless devices within a network. In some implementations, the wide area network transceiver(s) 204 may comprise a CDMA communication system suitable for communicating with a CDMA network of wireless base stations. In some implementations, the wireless communication system may comprise other types of cellular telephony networks, such as, for example, TDMA, GSM, WCDMA, LTE etc. Additionally, any other type of wireless networking technologies may be used, including, for example, WiMax (802.16), etc.

In some embodiments, an SPS receiver (also referred to as a global navigation satellite system (GNSS) receiver) 208 may also be included with the computing device 200. The SPS receiver 208 may be connected to the one or more antennas 202 for receiving satellite signals. The SPS receiver 208 may comprise any suitable hardware and/or software for receiving and processing SPS signals. The SPS receiver 208 may request information as appropriate from the other systems, and may perform the computations necessary to determine the position of the computing device 200 using, in part, measurements obtained by any suitable SPS procedure.

As further illustrated in FIG. 2, the example computing device 200 includes one or more sensors 212 coupled to a controller/processor 210, another processor 290, the sensors 212 can be used to implement the at least one sensor 120 of the computing device 100 illustrated in FIG. 1. The processor 210 can be used to implement the second processor 110 illustrated in FIG. 1, the processor 290 can be used to implement the first processor 105 illustrated in FIG. 1, and the sensors 212 can be used to implement the at least one sensor 120.

The sensors 212 may include motion sensors to provide relative movement and/or orientation information (which is independent of motion data derived from signals received by the wide area network transceiver(s) 204, the local area network transceiver(s) 206, and/or the SPS receiver 208). By way of example but not limitation, the motion sensors may include an accelerometer 212a, a gyroscope 212b, and a geomagnetic (magnetometer) sensor 212c (e.g., a compass), any of which may be implemented based on micro-electro-mechanical-system (MEMS), or based on some other technology. The one or more sensors 212 may further include an altimeter (e.g., a barometric pressure altimeter) 212d, a thermometer (e.g., a thermistor) 212e, an audio sensor 212f (e.g., a microphone) and/or other sensors. For example, the one or more sensors 212 can include one or more sensors that can be used to collect biometric and/or other data that can be used to determine whether a user of the computing device 200 is wearing the computing device. For example, the one or more sensors 212 can include a photoplethysmogram (PPG) sensor 212h that can be configured to obtain heartrate information for the user of the computing device 200, and can be used to determine whether the user is wearing the computing device 200 or has removed the computing device 200. The at least one sensor 120 can include a capacitive sensor 212i configured to generate a signal when a conductive material, such as human skin, comes into contact with the sensor. Such a conductive sensor can also be used to determine whether the user is wearing the computing device 200 or has removed the computing device 200. The sensors 212 can include an electroencephalography (EEG) sensor for measuring electrical activity of the brain of the user of the computing device 200. Other types of sensors could also be used to determine whether computing device 200 is being worn by the user or whether the computing device 200 has been removed by the user. The output of the one or more sensors 212 can be used by the processor 210 and/or the processor 290 to determine whether the user of the computing device 200 is wearing the computing device 200 and/or has removed the computing device 200. The processor 210 and/or the secondary processor 290 can be configured to perform various processes as discussed herein based on whether the user is wearing and/or has removed the computing device 200. As further shown in FIG. 2, in some embodiments, the one or more sensors 212 may also include a camera 212g (e.g., a charge-couple device (CCD)-type camera, a CMOS-based image sensor, etc.), which may produce still or moving images (e.g., a video sequence) that may be displayed on a user interface device, such as a display or a screen, and that may be further used to determine an ambient level of illumination and/or information related to colors and existence and levels of UV and/or infra-red illumination.

The processor(s) (also referred to as a controller) 210 may be connected to the local area network transceiver(s) 206, the wide area network transceiver(s) 204, the SPS receiver 208 and the one or more sensors 212. The processor may include one or more microprocessors, microcontrollers, and/or digital signal processors that provide processing functions, as well as other calculation and control functionality. The processor 210 may be coupled to storage media (e.g., memory) 214 for storing data and software instructions for executing programmed functionality within the mobile device. The memory 214 may be on-board the processor 210 (e.g., within the same IC package), and/or the memory may be external memory to the processor and functionally coupled over a data bus.

A number of software modules and data tables may reside in memory 214 and may be utilized by the processor 210 in order to manage both communications with remote devices/nodes, perform positioning determination functionality, and/or perform device control functionality. The application module 218 may be a process running on the processor 210 of the computing device 200, which may request one of the other modules of the computing device 200. Applications typically run within an upper layer of the software architectures and may be implemented in a rich execution environment of the processor 210 of the computing device 200.

The processor 210 may also include a trusted execution environment 140, which can be used implement the trusted execution environment 140 illustrated in computing device 100 illustrated in FIG. 1. The trusted execution environment 140 can be implemented as a secure area of the processor 210 that can be used to process and store sensitive data in an environment that is segregated from the rich execution environment in which the operating system and/or applications (such as those of the application module 218) may be executed. The trusted execution environment 140 can be configured to execute trusted applications that provide end-to-end security for sensitive data by enforcing confidentiality, integrity, and protection of the sensitive data stored therein. The trusted execution environment 140 can be used to store encryption keys, access tokens, and other sensitive data.

The computing device 200 may further include a user interface 250 providing suitable interface systems, such as a microphone/speaker 252, a keypad 254, and a display 256 that allows user interaction with the computing device 200. The microphone/speaker 252 (which may be the same or different from the audio sensor 212f) provides for voice communication services (e.g., using the wide area network transceiver(s) 204 and/or the local area network transceiver(s) 206). The keypad 254 may comprise suitable buttons for user input. The display 256 may include a suitable display, such as, for example, a backlit LCD display, and may further include a touch screen display for additional user input modes.

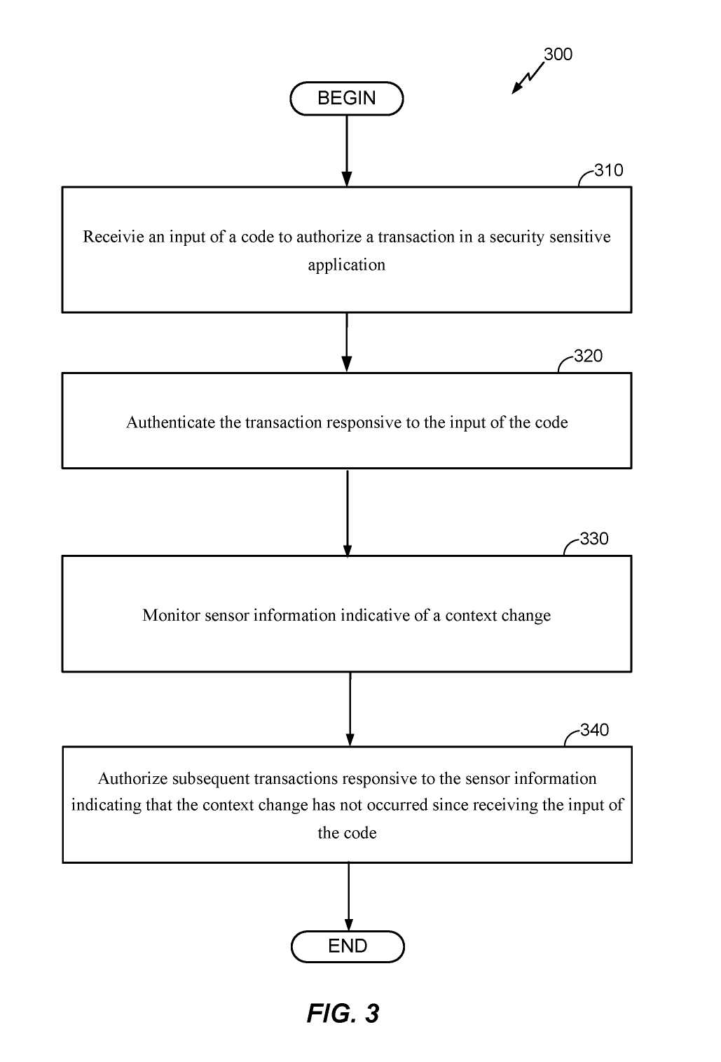

FIG. 3 is a flow diagram of an example process for secure transactions on a mobile device, which may comprise a wearable mobile device, in accordance with certain example embodiments. The process illustrated in FIG. 3 can be implemented using the computing device 100 illustrated in FIG. 1, which in turn may be implemented by the computing device 200 illustrated in FIG. 2.

An input of a code to authorize a transaction in a security sensitive application can be received (stage 310). The computing device 100 can be configured to prompt the user of the computing device 100 to enter a code to authorize a transaction with a security sensitive application. The security sensitive application can comprise an application that is executable on the computing device 100 that is configured to perform a transaction which is security sensitive. The application may comprise processor-executable code stored in a memory of the computing device 100 of FIG. 1. The application may be implemented by the application module 218 where the computing device is implemented by the computing device 200 illustrated in FIG. 2. The application can be executed by the second processor 110 and may be executed at least in part by the trusted execution environment 140 of the second processor 110.

The security sensitive transaction can include a financial transaction, such as purchasing or selling an item or services, or can include accessing or updating sensitive data, such as financial data, medical data, and/or other data comprising sensitive information. Other types of security sensitive transactions may also be performed. The security sensitive application can be an application that is configured to operate completely within in the trusted execution environment 140 of the second processor 110 or portions of the application that execute sensitive operations can be configured to operate within the trusted execution environment 140 while other portions of the application may be executed in the general purpose execution environment 145 of the second processor 110. The application can be configured to access sensitive data from a secure memory location of the trusted execution environment 140 and/or to perform a transaction with a remote server or content provider or to access sensitive data from the remote server or content provider. The security sensitive application can be configured to display a user interface on a display of the computing device 100 that the user to enter the code via a touchscreen and/or other user interface components of the computing device 100 that allow the user to interact with the computing device 100. The computing device 100 can also be configured to prompt the user to enter the code using haptic, audio, and/or visual feedback.

The transaction can be authenticated responsive to the input of the code (stage 320). The code may comprise various types of authentication credentials that can be used to determine whether to authorize the transaction. For example, the code may comprise alphanumeric input, a swipe pattern, and/or other type of input provided by a user of the computing device 100. At least a portion of the application can be implemented by the trusted execution environment 140, and the portion of the application implemented in the trusted execution environment 140 can be configured to compare the input of the code received from the user of the computing device 100 with a reference value stored in a secure memory location of the computing device 100 and/or to provide at least a portion of the input received from the user to a remote server for authentication. The code may be an authentication code that is used to unlock access to the computing device 100 and/or may be an authentication code that is used to unlock access to specific content on the computing device 100. The code may also be an application-specific authentication code that is associated with the security sensitive application.

The security sensitive application and/or the trusted execution environment 140 of the computing device 100 can be configured to permit the transaction to be completed responsive to the input of the correct code by the user. Accordingly, the security sensitive application can be configured to perform one or more actions to complete the requested transaction and may provide the user with audio, visual, and/or tactile feedback that the transaction has been completed successfully. The security sensitive application can also be configured to present information obtained as a result of the transaction to the user of the computing device 100 responsive to the transaction being completed. In the event that an incorrect code has been entered, the process may return to stage 310 where the user may once again prompted to enter the code in order to authorize the security sensitive transaction. The security sensitive application and/or the trusted execution environment 140 of the computing device 100 can be configured to lock the computing device 100, to prevent access to the security sensitive application, and/or require the user to provide one or more authentication credentials to unlock access to the computing device 100 and/or the security sensitive application and/or other security sensitive content on the computing device 100.

Sensor information indicative of a context change can be monitored (stage 330). The computing device 100 can comprise at least one sensor 120. The information from the sensor of the at least one sensor 120 can be used determine whether there is a context change that is indicative of a particular event. The computing device 100 can be configured such that the computing device 100 begins to monitor the sensor information obtained from the at least one sensor 120 once the code has been authenticated in stage 320. The computing device 100 can be configured to allow subsequent transactions of the same type with the same security sensitive application until the occurrence of the event indicative of the context change. In some implementations, the computing device 100 can be configured to allow subsequent transactions of the same or a different type with the same security sensitive application and/or other security sensitive applications on the computing device 100 until the occurrence of the event indicative of the context change. The computing device 100 can also be configured to allow the subsequent transactions for a predetermined amount of time after the code has been authenticated in stage 320 regardless of whether the context change occurs, and the user would be required to enter the code again once the predetermined amount of time has passed even though a context change has not occurred.

The at least one sensor 120 can comprise various types of sensors including a photoplethysmogram (PPG) sensor. A PPG sensor can be used to obtain heartrate information for the user of the computing device 100, and can be used to determine whether the user is wearing the computing device 100 or has removed the computing device 100. The at least one sensor 120 can comprise a capacitive sensor configured to generate a signal when a conductor, such as human skin, is in contact with the sensor. Such a conductive sensor can also be used to determine whether the user is wearing the computing device 100 or has removed the computing device 100. The at least one sensor 120 can also include an electroencephalography (EEG) sensor for measuring electrical activity of the brain. Other types of sensors could also be used to determine whether computing device 100 is being worn by the user or whether the computing device 100 has been removed by the user.

Other types of sensors may also be used. For example, the at least one sensor 120 can may comprise a barometric pressure sensor for sensing changes in barometric pressure, which may be indicative of the user of the computing device 100 entering or exiting an indoor environment, changing floors in a multistory building, or otherwise moving from a particular location. The at least one sensor 120 can include a gyroscopic sensor that can be used to sense changes in orientation of the computing device 100, a magnetometer sensor that can measure the magnetic field of the earth and can serve as a compass, a thermometer for measuring changes in the ambient temperature and/or for measuring temperature which could be indicative of whether the computing device 100 is being worn by the user or has been removed by the user, an accelerometer for measuring acceleration of the computing device 100, and/or other types of sensors.

The context change event can be depend on which types of sensors that comprise the at least one sensor 120 of the computing device 100 which determines the types of sensor data available to the computing device 100. The context change event can also be application specific. A first security sensitive application can be configured to recognize a first type of context change event and a second security sensitive application can be configured to recognize a second type of context change event.

Subsequent transactions can be authorized responsive to the sensor information indicating that the context change has not occurred since receiving the input of the code (stage 340). The trusted execution environment 140 and/or the security sensitive application can be configured to allow subsequent transactions with the security sensitive application to be performed without requiring that the user reenter the code received in stage 310 responsive to no context change having occurred. The trusted execution environment 140 and/or the security sensitive application can be configured to deny subsequent transactions responsive to the context change having occurred. The trusted execution environment 140 and/or the security sensitive application can be configured to request entry of the code responsive to the context change having occurred and to deny subsequent transactions until the code has been entered. For example, the trusted execution environment 140 and/or the security sensitive application can be configured to monitor whether the user has remove the computing device 100 since the code was input in stage 310, and to require that the user enter the code again in order to perform another transaction with the security sensitive application responsive to the computing device 100 having been removed. Removal of the computing device 100 could indicate that someone other than the authorized user may have who provided the code in stage 310 may have obtained the device and is attempting to execute a transaction with the security sensitive application. In the interest of security, the user is prompted to reenter the code. However, if the computing device 100 has not been removed since the user has provided the code in stage 310, then the computing device 100 is very likely to be under the control of the authorized user and subsequent transactions can safely be authorized.

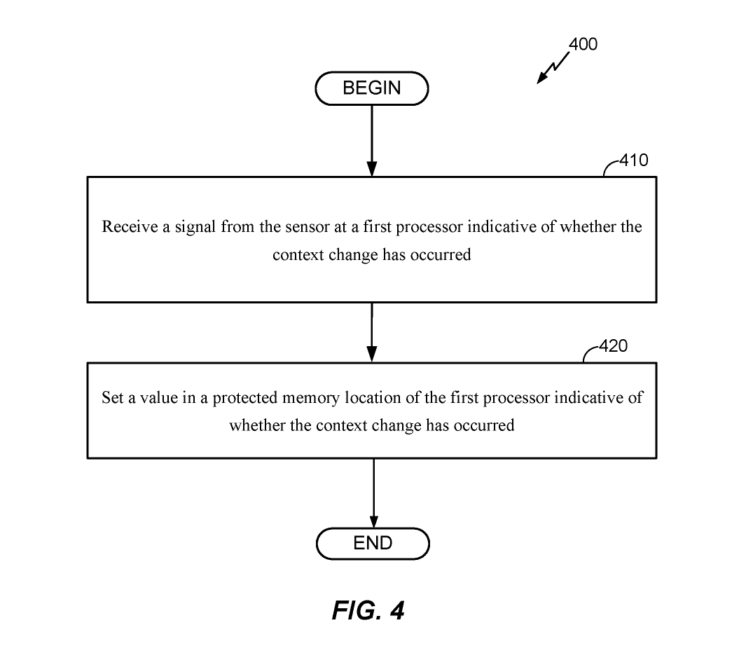

FIG. 4 is a flow diagram of a process for monitoring sensor information, in accordance with certain example embodiments. The process illustrated in FIG. 4 can be used to implement, at least in part, stage 330 of the process illustrated in FIG. 3. The process illustrated in FIG. 4 can be implemented by the computing device 100 illustrated in FIG. 1, which in turn may be implemented by the computing device 200 illustrated in FIG. 2.

A signal can be received from the sensor at a first processor 105 indicative of whether the context change has occurred (stage 410). The computing device 100 can be configured to include a first processor 105 and a second processor 110 as illustrated in FIG. 1. The first processor 105 can be configured interface with the at least one sensor 120, to monitor signals received from the at least one sensor 120, and to process these signals. The second processor 110 can be configured to operate a trusted execution environment 140 and a general purpose execution environment 145 and may also include a digital signal processing component. General purpose execution environment 145 can include the HLOS of the computing device 100 and/or other non-secure applications. As discussed above, the at least one sensor 120 can comprise various types of sensors, including but not limited to, a PPG sensor, a magnetometer, capacitive touch sensors, an accelerometer, and/or other types of sensors. The first processor 105 can be configured to monitor signals from the at least one sensor 120, which can free up the second processor 110 to perform other tasks or to power down at least some components of the second processor 110 if the second processor does not currently have a processing tasks to perform.

A value can be set in a protected memory location of the first processor indicative of whether the context change has occurred (stage 420). The first processor 105 can be configured to identify when a context shift occurs and to update a status indicator 180 in a protected memory of the first processor 105 responsive to the context shift occurring. The status indicator 180 in the protected memory of the first processor 105 is accessible to the trusted execution environment 140 of the second processor 110 via a secure interface between the first processor 105 and the second processor 110. The status indicator 180 can comprise information indicating whether a context change has occurred since the code was entered in stage 310. The second processor 110 can be configured to signal to the first processor 105 to check the current context of the computing device 100 responsive to the code being entered. The first processor 105 can monitor signals from the at least one sensor 120 and make a determination whether a context change has occurred since the first processor 105 signals to the second processor 110 to begin monitoring for a context change. The first processor 105 can also provide the current context information to the second processor 110 via the secure interface between the first processor 105 and the second processor 110. The first processor 105 can use this information to determine whether to allow subsequent transactions based on the current context as well. For example, the first processor 105 can be configured to prompt the user of the computing device 100 to enter the code again prior to authorizing any subsequent transactions if the computing device 100 was not being worn at the time that the code was entered.

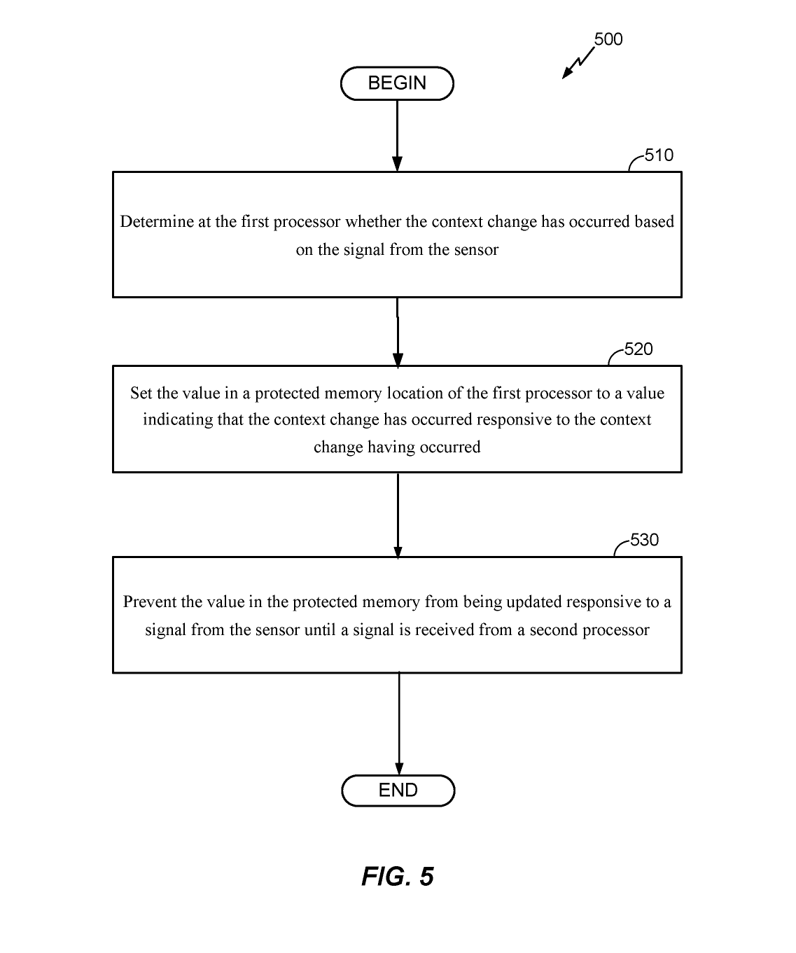

FIG. 5 is a flow diagram of a process for monitoring sensor information, in accordance with certain example embodiments. The process illustrated in FIG. 5 can be used to implement, at least in part, stage 410 of the process illustrated in FIG. 4. The process illustrated in FIG. 5 can be implemented by the first processor 105 of the computing device 100. The first processor 105 of the computing device 100 can be configured to continue to monitor signals from the at least one sensor 120. Meanwhile, at least some components of the second processor 110 may be at least partially powered down when not required to perform processing functions using the trusted execution environment 140, the general purpose execution environment 145, and/or the DSP processing functionality, in order to conserve power on the computing device 100.

A determination can be made at the first processor 105 whether the context change has occurred based on the signal from the sensor (stage 510). As discussed above, the at least one sensor 120 can comprise one or more sensors that can provide information regarding a current context of the computing device 100. For example, signals from the at least one sensor 120 can be used to determine whether the computing device 100 is being worn by a user or has been removed. Other types of context changes can also be determined based on the signals received from the at least one sensor 120. The first processor 105 can be configured to access context change event information associated with the security sensitive application from a memory of the first processor 105 or a memory of the computing device 100 accessible by the first processor 105, and to make a determination whether such a context change event has occurred based on the signals received from the at least one sensor 120. A context change event may be associated with signals from one or more types of sensors, and the context change event information may comprise information that indicates which types of sensors may be used to determine whether a particular context change event has occurred. Different computing devices may have different combinations of sensors, and the context change event information may be customized for the particular combination of sensors included in a particular computing device or may be a device-independent version of the context change information that may be used for multiple different computing devices which may have different processing capabilities and sensor capabilities.

The value in the protected memory location can be set (stage 520). The first processor 105 can be configured to set a value in a protected portion of memory of the first processor 105 indicating whether a context change has occurred since the first processor 105 has been instructed by the second processor 110 to begin monitoring for a context change event. The first processor 105 can be configured to store the value in a status indicator 180 memory location that is located in a portion of memory that can only be accessed by privileged processes by executed by the first processor 105 and/or by the trusted execution environment 140 of the second processor 110 via the secure interface between the first processor 105 and the second processor 110.

The value in the protected memory can be prevented from being updated responsive to a signal from the sensor until a signal is received from a second processor (stage 530). The first processor 105 can be configured to prevent the status indicator 180 value stored in the protected memory from being updated responsive to a subsequent signal from the at least one sensor 120 that is indicative of a context change. The purpose of this stage is to prevent a situation where the event that caused the context change is ended or reversed and the status indicator 180 being incorrectly updated. For example, if the status indicator 180 is being used represent a context change in which the user of the computing device 100 has removed the computing device 100, the status indicator 180 can be set with a value to indicate that the wearer has removed the computing device 100 responsive to signals from a sensor of the at least one sensor 120 indicative that the device has been removed by the user even if subsequent sensor data indicates that the device is once again being worn by a user. This approach prevents a second user from putting on the wearable device that has just been taken off by a first user and being able to request transaction with a security sensitive application without having to enter the code to authenticate such a transaction. Otherwise, the second user could piggyback off the first user's credentials to authorize subsequent transactions since the first user has entered the code to authenticate the first transaction. The first processor 105 can be configured to maintain the value of the status indicator 180 and to prevent the value of the status indicator 180 from being updated until a signal is received from the second processor 110. The signal from the second processor 110 may be received via the secure interface between the first processor 105 and the second processor 110. The signal 180 can instruct the first processor 105 to redetermine the value of the status indicator 180.

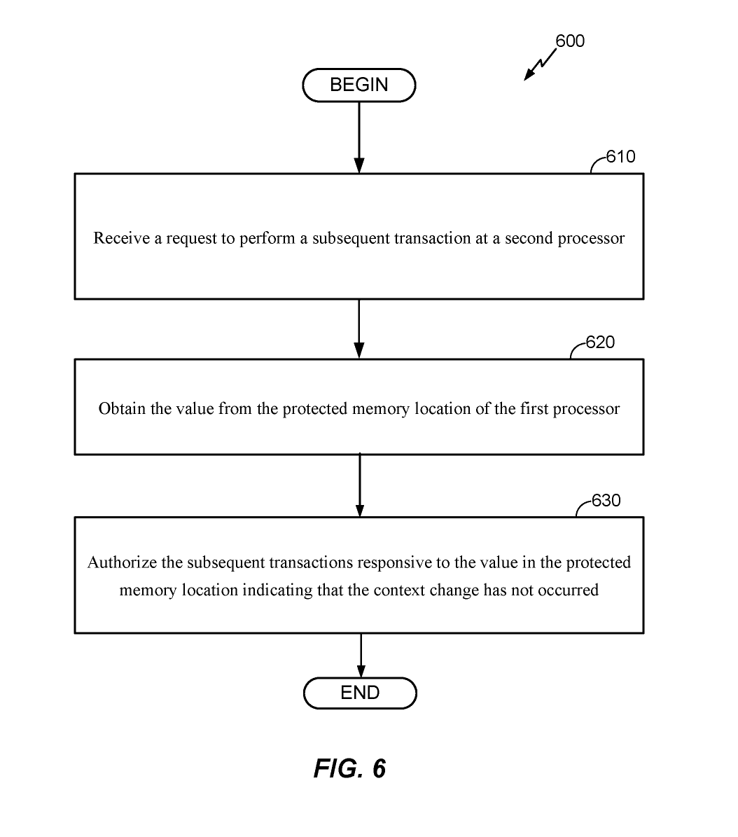

FIG. 6 is a flow diagram of a process for authorizing transactions, in accordance with certain example embodiments. The process illustrated in FIG. 6 can be used to implement, at least in part, stage 340 of the process illustrated in FIG. 3. The process illustrated in FIG. 6 can be implemented using the computing device 100 illustrated in FIG. 1, which may in turn be implemented using the computing device 200 illustrated in FIG. 2. The process illustrated in FIG. 5 can be implemented by the first processor 105 of the computing device 100.

A request to perform a subsequent transaction can be received at the second processor (stage 610). The security sensitive application or a user of the computing device 100 may have initiated the request to perform the subsequent transaction. A user of the computing device 100 can initiate a subsequent transaction to perform a transaction after the transaction of stage 320 of the process of FIG. 3 was performed. For example, the user may attempt to initiate another transaction to purchase goods or services, to initiate a financial transaction, and/or to obtain sensitive data after the first transaction was performed after the code was entered in stage 310 of the process of FIG. 3. The user is not prompted for the code again at this point in the process, but the user may be prompted to reenter the code if the second processor 110 determines that a context change has occurred.

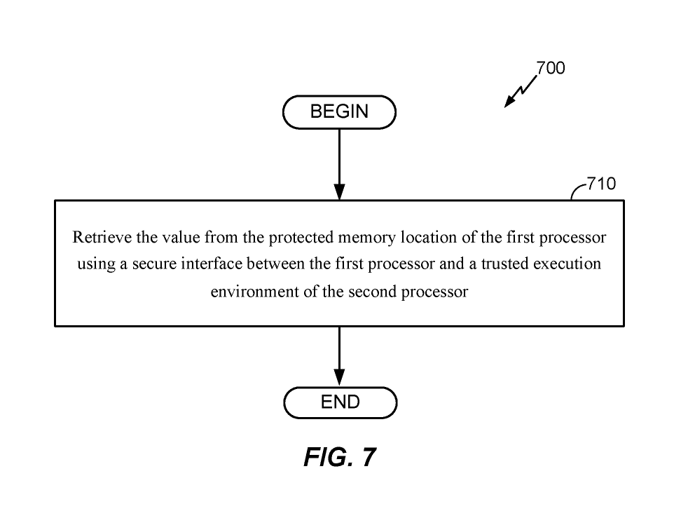

The value from the protected memory location of the first processor 105 can be obtained (stage 620). The second processor 110 can be configured to obtain the status indicator 180 from the first processor 105 which indicates whether a context change has occurred since the second processor 110 indicated to the first processor 105 that the first processor should be monitoring the signals from the at least one sensor 120 to determine whether a context change has occurred. The trusted execution environment 140 of the second processor 110 can assert a signal over the secure interface between the first processor 105 and the second processor 110 to provide the trusted execution environment 140 with exclusive access to the secure interface. The first processor 105 can be configured to ignore requests from the general purpose execution environment 145 while the signal from the trusted execution environment 140 is assert. Alternatively, the first processor 105 can be configured to prevent the general purpose execution environment 145 from accessing the secure interface while the signal is asserted by the trusted execution environment 140. FIG. 7 illustrates an example process that utilizes such an approach for obtaining the value of the status indicator 180 from the protected memory location of the first processor 105.

The subsequent transaction can be authorized responsive to the value in the protected memory location indicating that the context change has not occurred (stage 630). The second processor 110 can be configured to authorize the subsequent transaction responsive to there not having been a context change since the code was last entered by a user of the computing device 100. However, if a context change has occurred, the second processor 110 can be configured to require that the user of the computing device 100 reenter the code prior to authorizing the subsequent transaction.

FIG. 7 is a flow diagram of a process for obtaining information from a protected memory location of a processor, in accordance with certain example embodiments. The process illustrated in FIG. 7 can be used to implement, at least in part, stage 620 of the process illustrated in FIG. 6. The process illustrated in FIG. 5 can be implemented by the first processor 105 of the computing device 100.

The value of the status indicator can be retrieved from the protected memory location of the first processor using a secure interface between the first processor and the trusted execution environment of the second processor (stage 710). As discussed above with respect to FIG. 1, the first processor 105 and the second processor 110 can be configured to multiplex a single data interface, data interface 175, between a secure mode and a non-secure mode. The trusted execution environment 140 of the second processor 110 can control which mode that the data interface 175 is operating in by asserting a signal on a pin of the second processor 110 that indicates that the data interface 175 is being operated in the secure operating mode. The second processor 110 can be configured to send a signal to the first processor 105 to cause the first processor to send the current value of the status indicator 180, which is stored in a protected memory location of the first processor 105, to the second processor 110 via the data interface 175. The secure interface between the first processor 105 and the second processor 110 can include a first line 185 and second line 190 which represent a logical communication link between the first processor 105 and the second processor 110. The first line 185 and the second line 190 may be implemented as separate physical interfaces between the first processor 105 and the second processor 110 or may be implemented using the same physical interface. The first line 185 and the second line 190 may be implemented as a Serial Peripheral Interface (SPI) bus connecting the first processor 105 and the second processor 110. The second processor 110 can be configured to operate as the SPI master device and the first processor 105 can be configured to operate as the SPI slave device. Other types of physical interfaces between the first processor 105 and the second processor 110 can also be used.

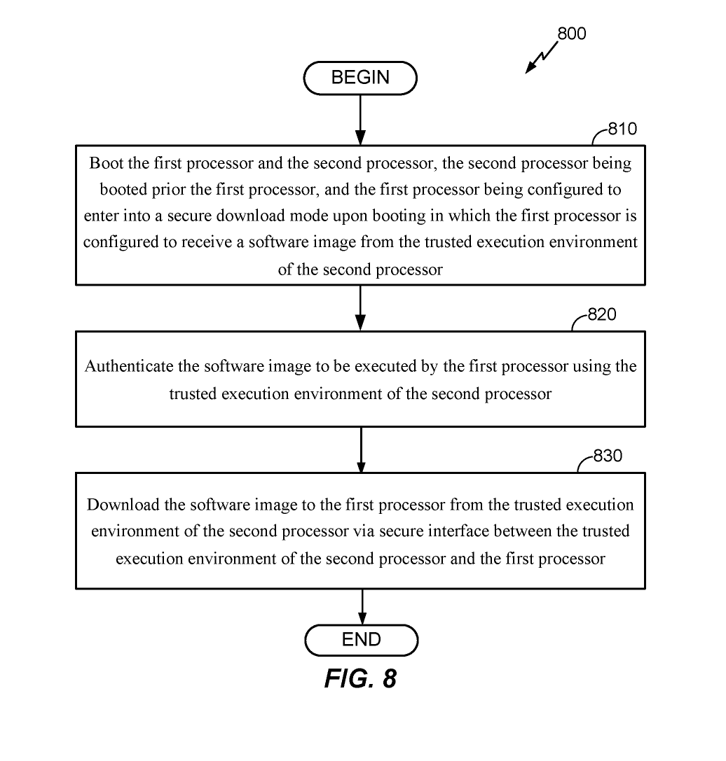

FIG. 8 is a flow diagram of a process for initializing a first processor and a second processor, in accordance with certain example embodiments. The process illustrated in FIG. 8 can be performed prior to the process illustrated in FIG. 3 and may be implemented as stage of the process of FIG. 3 that precede the stages 310, 320, 330, and 340 of that process or the process of FIG. 8 may be a standalone process. The process illustrated in FIG. 8 can be implemented by the first processor 105 of the computing device 100. The processes illustrated in FIG. 8 can be used to provide executable program code to a multi-processor computing device, such as the computing device 100 illustrated in FIG. 1 or the computing device 200 illustrated in FIG. 2. The process illustrated in FIG. 8 can help to simplify the process for distributing and installing software on such multi-processor system, by having one processor configured to determine whether the software image has been digitally signed by one or more entities from which the computing device 100 is configured to accept and install software images and update.

The process illustrated in FIG. 8 can be used to secure an external processor, such as the first processor 105. The first processor 105 is external to the second processor 110, which is configured to handle processing for the trusted execution environment 140, the general purpose execution environment 145, and the DSP functional block 150. The first processor 105 may be a less powerful, but less power intensive processor than the second processor 110 in some implementations or may be identical to the second processor 110 in other implementations.

One conventional technique that can be used to secure an external processor, such as the first processor 105, is to only allow the external processor to execute program code that has been signed using one of the various techniques known in the art for digitally signing the program code to guarantee that the program code has not been altered since generated and has been signed by a known and reliable source in order to establish a chain of trust with respect to the program code. However, as the program code spans multiple processors, each of which may have independent code bases, the complexity of developing and maintaining a key distribution mechanism for multiple build systems can become unduly complicated.

The process illustrated in FIG. 8 can be used reduce the number of software images that need to be signed, and thereby also reduce the complexity of key distribution associated with the signing of such software images, by producing a single software image bundle that comprises one or more software images for the first processor 105 and the second processor 110. An image can comprise software libraries, operating system files, application content, audiovisual content (e.g., images, video content, and/or audio content), configuration files, and/or other content that may be used by a computing device 100. A bundle of images may include multiple different types of images for one or both of the processors.

A master signed software image bundle can be generated for both the first processor 105 and the second processor 110 at the factory manufacturing the computing device 100, by a reseller installing customized software on the computing device 100, or by another trusted sources, such as a wireless network provider for which the computing device 100 is customized to operate with the provider's network. The trusted execution environment 140 of the second processor 110 can be configured to authenticate the master signed image bundle and to propagate the authenticated software image to the first processor 105 via a secure interface.

The first processor 105 does not need to be configured to authenticate the program code included in the master signed software bundle because the trusted execution environment 140 of the second processor 110 is configured to handle this task. The first processor 105 can be configured to only accept the download of a software image from the trusted execution environment 140 of the second processor 110 that has been authenticated by the trusted execution environment 140 of the second processor 110. The software can be downloaded via the secure interface between the two processors to reduce the threat that corrupted or hostile software may be installed for the first processor 105.

The process illustrated in FIG. 8 can be implemented at part of a secure software update program code that is executed by the trusted execution environment 140 of the computing device 100. The secure software update program code can be configured to cause the computing device 100 to periodically check for software updates for the program code executed by the second processor 110 and/or the first processor 105 and to download the associated software image or bundle of software images to the computing device 100.

The process of FIG. 8 can begin with the first processor 105 and the second processor 110 being booted (stage 810). The computing device 100 may be configured such that the second processor 110 is booted prior to the first processor 105. The first processor 105 can be configured to enter into a secure download mode upon booting in which the first processor 105 is configured to receive a software image from the trusted execution environment 140 of the second processor 110. The first processor 105 can be configured to wait for the second processor 110 to download a software image comprising code to be executed by the first processor 105. The first processor 105 is configured to only accept for download a software image that is provided over the secure interface between the first processor 105 and the second processor 110. Stage 810 can be altered such that the first processor 105 only is booted. For example, a software image may be accessed by the second processor 110 that includes only updates to the software of the first processor 105. The second processor 110 can be configured to authenticate the software update The second processor 110 can be configured to send a signal to the first processor 105 to cause the first processor 105 to reboot and enter into the secure download mode. The process may then continue with stage 820.

A software image can be authenticated by the second processor 110 using the trusted execution environment 140 of the second processor (stage 820). The trusted execution environment 140 of the second processor 110 can be configured to access a signed bundle of processor-executable software. The signed bundle of software can include software solely to be provided to the first processor 105 or can comprise a master bundle of software that includes software intended for both the first processor 105 and the second processor 110. The trusted execution environment 140 can be configured to provide the portion of the master bundle of software intended for the first processor 105 to the first processor 105 via the secure interface between the processors. The trusted execution environment 140 can be configured to authenticate the software image to be downloaded to the first processor 105 using conventional means known in the art, such as verifying that the software image has been signed one or more digital certificates of known origin. For example, the software image may be provided by a device manufacturer, reseller, or other known and trusted content provider. The trusted execution environment 140 can be configured to delete the software image if the authentication fails and/or perform other remedial measures. For example, the trusted execution environment 140 can be configured to provide an indication to a user of the computing device 100 that software update failed. The trusted execution environment 140 can be configured to notify a provider of the software image that the software update using the image failed, which may trigger the software provider to verify the software image. The trusted execution environment 140 can also be configured to download the software image again and to attempt to authenticate the software image again. The original download may have been corrupted.

The software image can be downloaded to the first processor 105 from the trusted execution environment 140 of the second processor 110 via secure interface between the trusted execution environment of the second processor 110 and the first processor 105 (stage 830). The secure interface can include a first line 185 and a second line 190 which represent a logical communication link between the first processor 105 and the second processor 110. The first processor 105 can be configured to only accept the download of the software image via this secure interface to prevent unsecure software images from being downloaded to the first processor 105 from outside of the trusted execution environment 140 of the second processor 110. The second processor 110 can be configured to process the software image to prepare the software image for execution by the first processor 105 and to begin executing the software. The program code can include instructions configured to cause the first processor 105 to monitor the signals generated by the at least one sensor 120 and to set the status indicator 180 responsive to a context change. The software image can also include configuration data that can be used by the second processor to perform the various functions discussed herein, including information for identifying which types of sensor data is indicative of a context change. The information can include application specific data for more than security sensitive application for identifying what constitutes a context change. Other types of program code may also be included in the software image in addition to or instead of the items discussed above.

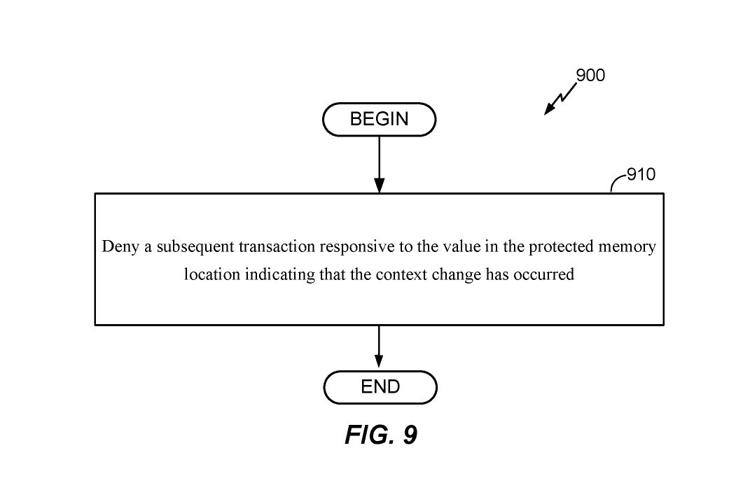

FIG. 9 is a flow diagram of a process for obtaining information from a protected memory location of a processor, in accordance with certain example embodiments. The process illustrated in FIG. 9 can be used to implement, at least in part, the process illustrated in FIG. 6. The process illustrated in FIG. 5 can be implemented by the first processor 105 of the computing device 100.

A subsequent transaction can be denied responsive to the value in the protected memory location indicating that the context change has occurred (stage 910). The second processor 110 can be configured to deny a subsequent transaction request received since the transaction authenticated in stage 320 of the process of FIG. 1. The second processor 110 can obtain the value of the status indicator 180 from the first processor 105 which is indicative of whether there was a context change since the transaction in stage 320 which was executed after the code received in stage 310 was authenticated. The second processor 110 can be configured to deny the subsequent transaction responsive to a context change having occurred. The second processor 110 can also be configured to present a request to the user of the computing device 100 to reenter the code. If the user enters the code, the subsequent transaction can be performed by the second processor 110, and the second processor 110 can instruct the first processor 105 monitor the signals from the at least one sensor 120 to determine whether a context change occurs.

An example implementation according to the techniques disclosed herein can include:
1A. A non-transitory, computer-readable medium, having stored thereon computer-readable instructions for secure transactions on a mobile device, comprising instructions configured to cause at least one processor to:
   receive an input of a code to authorize a transaction in a security sensitive application;
   authenticate the transaction responsive to the input of the code;
   monitor sensor information indicative of a context change; and
   authorize subsequent transactions responsive to the sensor information indicating that the context change has not occurred since receiving the input of the code.
2A. The non-transitory, computer-readable medium of example 1A, wherein the context change is indicative of the mobile device having been removed by a user of the mobile device.
3A. The non-transitory, computer-readable medium of example 1A, wherein the mobile device comprises a photoplethysmogram (PPG) sensor, and the instructions configured to cause the at least one processor to monitor the sensor information comprise instructions configured to cause the at least one processor to monitor the sensor information from the PPG sensor.
4A. The non-transitory, computer-readable medium of example 1A, wherein the instructions configured to cause the at least one processor to monitor the sensor information indicative of the context change further comprise instructions configured to cause the at least one processor to:
   receive a signal from a sensor at a first processor indicative of whether the context change has occurred; and
   set a value in a protected memory location of the first processor indicative of whether the context change has occurred.
5A. The non-transitory, computer-readable medium of example 4A, wherein the signal from the sensor is indicative of whether the mobile device is being worn by a user of the mobile device, and wherein the value in the protected memory location is indicative of whether the mobile device is being worn by the user of the mobile device.
6A. The non-transitory, computer-readable medium of example 4A, wherein the instructions configured to cause the at least one processor to set the value in the protected memory location of the first processor indicative of whether the context change has occurred comprise instructions configured to cause the at least one processor to:
   determine at the first processor whether the context change has occurred based on the signal from the sensor;
   set the value in the protected memory location of the first processor to a value indicating that the context change has occurred responsive to the context change having occurred; and
   prevent the value in the protected memory location from being updated responsive to a signal from the sensor until a signal is received from a second processor.
7A. The non-transitory, computer-readable medium of example 4A, wherein the instructions to cause the at least one processor to authorize the subsequent transactions responsive to the sensor information indicating that the context change has not occurred since receiving the input of the code further comprise instructions configured to cause the at least one processor to:
   receive a request to perform a subsequent transaction at a second processor;
   obtain the value from the protected memory location of the first processor; and
   authorize the subsequent transactions responsive to the value in the protected memory location indicating that the context change has not occurred.
8A. The non-transitory, computer-readable medium of example 7A, wherein the instructions configured to cause the at least one processor to obtain the value from the protected memory location of the first processor further comprise instructions configured to cause the at least one processor to:
   retrieve the value from the protected memory location of the first processor using a secure interface between the first processor and a trusted execution environment of the second processor.
9A. The non-transitory, computer-readable medium of example 7A, further comprising instruction configured to cause the at least one processor to:
   deny the subsequent transaction responsive to the value in the protected memory location indicating that the context change has occurred.
10A. The non-transitory, computer-readable medium of example 9A, further comprising instructions configured to cause the at least one processor to:
   request, by the second processor, entry of the code to authorize the subsequent transaction; and
   request, by the second processor, that the first processor make a determination whether a user is wearing the mobile device based on the sensor information and set the value in the protected memory location based on the sensor information.
11A. The non-transitory, computer-readable medium of example 7A, further comprising instructions configured to cause the at least one processor to:
   boot the first processor and the second processor, the second processor being booted prior the first processor, and the first processor being configured to enter into a secure download mode upon booting in which the first processor is configured to receive a software image from a trusted execution environment of the second processor;
   authenticate the software image to be executed by the first processor using the trusted execution environment of the second processor; and
   download the software image to the first processor from the trusted execution environment of the second processor via secure interface between the trusted execution environment of the second processor and the first processor.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

Memory may be implemented within the computing-based device or external to the device. As used herein the term “memory” refers to any type of long term, short term, volatile, nonvolatile, or other memory and is not to be limited to any particular type of memory or number of memories, or type of media upon which memory is stored.

If implemented in-part by hardware or firmware along with software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

As used herein, a mobile device or station (MS) refers to a device such as a cellular or other wireless communication device, a smartphone, tablet, personal communication system (PCS) device, personal navigation device (PND), Personal Information Manager (PIM), Personal Digital Assistant (PDA), laptop or other suitable mobile device which is capable of receiving wireless communication and/or navigation signals, such as navigation positioning signals. The term “mobile station” (or “mobile device” or “wireless device”) is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, tablet devices, etc., which are capable of communication with a server, such as via the Internet, WiFi, or other network, and to communicate with one or more types of nodes, regardless of whether satellite signal reception, assistance data reception, and/or position-related processing occurs at the device, at a server, or at another device or node associated with the network. Any operable combination of the above are also considered a “mobile station.” A mobile device may also be referred to as a mobile terminal, a terminal, a user equipment (UE), a device, a Secure User Plane Location Enabled Terminal (SET), a target device, a target, or by some other name.

While some of the techniques, processes, and/or implementations presented herein may comply with all or part of one or more standards, such techniques, processes, and/or implementations may not, in some embodiments, comply with part or all of such one or more standards.

What is claimed:

1. A method for secure transactions on a mobile device, the method comprising:
receiving an input of a code to authorize a transaction in a security sensitive application;
authenticating the transaction responsive to the input of the code;
monitoring sensor information indicative of a context change; and
authorizing subsequent transactions responsive to the sensor information indicating that the context change has not occurred since receiving the input of the code.

2. The method of claim 1, wherein the context change is indicative of the mobile device having been removed by a user of the mobile device.

3. The method of claim 1, wherein the mobile device comprises a photoplethysmogram (PPG) sensor, and monitoring the sensor information comprises monitoring the sensor information from the PPG sensor.

4. The method of claim 1, wherein monitoring the sensor information indicative of the context change further comprises:
receiving a signal from a sensor at a first processor indicative of whether the context change has occurred; and
setting a value in a protected memory location of the first processor indicative of whether the context change has occurred.

5. The method of claim 4, wherein the signal from the sensor is indicative of whether the mobile device is being worn by a user of the mobile device, and wherein the value in the protected memory location is indicative of whether the mobile device is being worn by the user of the mobile device.

6. The method of claim 4, wherein setting the value in the protected memory location of the first processor indicative of whether the context change has occurred comprises:
determining at the first processor whether the context change has occurred based on the signal from the sensor;
setting the value in the protected memory location of the first processor to a value indicating that the context change has occurred responsive to the context change having occurred; and
preventing the value in the protected memory location from being updated responsive to the signal from the sensor until a signal is received from a second processor.

7. The method of claim 4, wherein authorizing the subsequent transactions responsive to the sensor information indicating that the context change has not occurred since receiving the input of the code further comprises:
receiving a request to perform a subsequent transaction at a second processor;
obtaining the value from the protected memory location of the first processor; and
authorizing the subsequent transactions responsive to the value in the protected memory location indicating that the context change has not occurred.

8. The method of claim 7, wherein obtaining the value from the protected memory location of the first processor further comprises:
retrieving the value from the protected memory location of the first processor using a secure interface between the first processor and a trusted execution environment of the second processor.

9. The method of claim 7, further comprising:
denying the subsequent transaction responsive to the value in the protected memory location indicating that the context change has occurred.

10. The method of claim 9, further comprising:
requesting, by the second processor, entry of the code to authorize the subsequent transaction; and
requesting, by the second processor, that the first processor make a determination whether a user is wearing the mobile device based on the sensor information and set the value in the protected memory location based on the sensor information.

11. The method of claim 7, further comprising:
booting the first processor and the second processor, the second processor being booted prior the first processor, and the first processor being configured to enter into a secure download mode upon booting in which the first processor is configured to receive a software image from a trusted execution environment of the second processor;
authenticating the software image to be executed by the first processor using the trusted execution environment of the second processor; and
downloading the software image to the first processor from the trusted execution environment of the second processor via secure interface between the trusted execution environment of the second processor and the first processor.

12. A mobile device comprising:
a first processor and a second processor being communicatively coupled to enable communications between the first processor and the second processor,
the second processor being configured to
receive an input of a code to authorize a transaction in a security sensitive application, and
authenticate the transaction responsive to the input of the code;
the first processor being configured to
monitor sensor information indicative of a context change, and
provide information indicative of the context change to the second processor;
the second processor being further configured to
authorize subsequent transactions responsive to the information indicating that the context change has not occurred since receiving the input of the code.

13. The mobile device of claim 12, wherein the context change is indicative of the mobile device having been removed by a user of the mobile device.

14. The mobile device of claim 12, wherein the mobile device comprises a photoplethysmogram (PPG) sensor, and the first processor is configured to monitor the sensor information from the PPG sensor.

15. The mobile device of claim 12, wherein the first processor being configured to monitor the sensor indicative of the context change is further configured to:
receive a signal from a sensor at the first processor indicative of whether the context change has occurred; and
set a value in a protected memory location of the first processor indicative of whether the context change has occurred.

16. The mobile device of claim 15, wherein the signal from the sensor is indicative of whether the mobile device is being worn by a user of the mobile device, and wherein the value in the protected memory location is indicative of whether the mobile device is being worn by the user of the mobile device.

17. An apparatus for secure transactions on a mobile device, the apparatus comprising:
means for receiving an input of a code to authorize a transaction in a security sensitive application;
means for authenticating the transaction responsive to the input of the code;
means for monitoring sensor information indicative of a context change; and
means for authorizing subsequent transactions responsive to the sensor information indicating that the context change has not occurred since receiving the input of the code.

18. The apparatus of claim 17, wherein the context change is indicative of the mobile device having been removed by a user of the mobile device.

19. The apparatus of claim 17, wherein the mobile device comprises a photoplethysmogram (PPG) sensor, and the means for monitoring the sensor information comprises means for monitoring the sensor information from the PPG sensor.

20. The apparatus of claim 17, wherein the means for monitoring the sensor information indicative of the context change further comprises:
means for receiving a signal from a sensor at a first processor indicative of whether the context change has occurred; and
means for setting a value in a protected memory location of the first processor indicative of whether the context change has occ
